(19) United States
(12) Patent Application Publication
(10) Pub. No.: US 2022/0245734 A1
(43) Pub. Date: Aug. 4, 2022

(54) INTERACTIVE METHOD AND DEVICE ON SOCIAL MEDIA ACCOUNTS

(71) Applicant: BEIJING DAJIA INTERNET INFORMATION TECHNOLOGY CO., LTD., Beijing (CN)

(72) Inventors: Ziyang WANG, Beijing (CN); Zedong HOU, Beijing (CN); Jin LIANG, Beijing (CN); Ran LI, Beijing (CN); Yue ZHANG, Beijing (CN)

(21) Appl. No.: 17/454,811

(22) Filed: Nov. 13, 2021

(30) Foreign Application Priority Data
Jan. 25, 2021 (CN) 202110099278.9

(51) Int. Cl. G06Q 50/00

(52) U.S. Cl. CPC G06Q 50/01

(57) ABSTRACT

The disclosure can provide an interactive method, an electronic device, and a storage medium for interacting on social media using social media accounts. The method includes: obtaining, from a requesting account, an interactive request to interact with a target group, wherein a social relationship between accounts in the target group satisfies a target type; determining a type of a social relationship between the requesting account and each account in the target group; and performing the interactive request based on the requesting account and the target group in response to the type of the type of the social relationship is the same as the target type

### CROSS-REFERENCE TO RELATED APPLICATION

This application claims priority to Chinese Patent Application No. 202110099278.9, filed on Jan. 25, 2021, the content of which is hereby incorporated by reference into this disclosure.

### TECHNICAL FIELD

The disclosure relates to the field of communication techniques, and more particularly, to methods, electronic devices, and storage media for interacting on social media using social media accounts.

### BACKGROUND

The development and widespread use of Internet technology brings about the notion of “group” in social media applications. A group is a platform that may attract different users for chatting.

In the related art, a user may choose a group to join based on the networking preferences and interactions with other members in that group. A user having one social relationship type may share limited topics with users having different social relationship types in the same group. Therefore, one user may have a relatively unpleasant experience due to the low interaction with other users having different social relationship types.

### SUMMARY

According to a first aspect of the disclosure, a method for interacting on social media using social media accounts applicable to an electronic device, is provided. The method includes: obtaining, from a requesting account, an interactive request to interact with a target group, wherein a social relationship between accounts in the target group satisfies a target type; determining a type of a social relationship between the requesting account and each account in the target group; and fulfilling the interactive request in response to determining that the type of the social relationship is the same as a target type.

According to a second aspect of the disclosure, an electronic device is provided. The electronic device includes a processor and a memory for storing instructions executable by the processor. The processor is configured to execute the instructions to perform the method provided in the first aspect of the disclosure.

According to a third aspect of the disclosure, a computer-readable storage medium is provided. The computer-readable storage medium has instructions stored therein. When the instructions stored in the computer-readable storage medium is performed by a processor of an electronic device, the electronic device is caused to perform the method provided in the first aspect of the disclosure.

It is to be understood that both the foregoing general description and the following detailed description are exemplary and explanatory only and are not restrictive of the disclosure.

### BRIEF DESCRIPTION OF THE DRAWINGS

The drawings incorporated herein constitute a part of this specification, illustrate embodiments consistent with the disclosure and, together with the description, serve to explain the principles of the disclosure. The drawing does not constitute an improper limitation of the disclosure.

FIG. 1 is a schematic diagram illustrating a hardware structure of an electronic device, according to some embodiments of the disclosure.

FIG. 2 is a flowchart illustrating a method for interacting on social media using social media accounts, according to some embodiments of the disclosure.

FIG. 3 is a flowchart illustrating a method for obtaining a list of group identifiers, according to some embodiments of the disclosure.

FIG. 4 is a schematic diagram illustrating a display interface, according to some embodiments of the disclosure.

FIG. 5 is a flowchart illustrating a method for interacting on social media using social media accounts, according to some embodiments of the disclosure.

FIG. 6 is a flowchart illustrating a method for interacting on social media using social media accounts, according to some embodiments of the disclosure.

FIG. 7 is a schematic diagram illustrating a display interface, according to some embodiments of the disclosure.

FIG. 8 is a flowchart illustrating a method for interacting on social media using social media accounts, according to some embodiments of the disclosure.

FIG. 9 is a flowchart illustrating a method for interacting on social media using social media accounts, according to some embodiments of the disclosure.

FIG. 10 is a schematic diagram illustrating a display interface, according to some embodiments of the disclosure.

FIG. 11 is a schematic diagram illustrating a display interface, according to some embodiments of the disclosure.

FIG. 12 is a block diagram illustrating an apparatus for interacting on social media using social media accounts, according to some embodiments of the disclosure.

### DETAILED DESCRIPTION

To enable those skilled in the art to better understand the technical solutions of the disclosure, the technical solutions in embodiments of the disclosure will be described clearly and completely with reference to the drawings.

It should be noted that the terms such as “first” and “second” in the specification and claims of the disclosure and the drawings are used to distinguish similar objects, and not necessarily used to describe a specific order or sequence. It should be understood that the terms used in this way may be interchanged with each other under appropriate circumstances so that the embodiments of the disclosure described herein may be implemented in a sequence other than those illustrated or described herein. The implementation manners described in the following embodiments do not represent all implementation manners consistent with the disclosure. Rather, they are merely examples of apparatuses and methods consistent with some aspects of the disclosure as detailed in the appended claims. Data involved in the following embodiments may be authorized by accounts or fully authorized by all parties.

The methods for interacting on social media using social media accounts provided in some embodiments of the disclosure, are applicable to the scenarios where an account uses a video application. The account in the disclosure may log in to the video application for networking. Generally, an account may join a group on the video application based on the networking preference and interact with other accounts in the group. In the related art, accounts in an existing group may have different types of social relationship and accounts having different types of social relationship may share limited topics with one another. Therefore, one account may have a relatively unpleasant experience due to the low interaction with other accounts having different types of social relationship.

In the related art, a fixed amount of traffic will be allocated by a system to any video published by an account. If the account wants to increase a playback rate of one video, it may leave comments under other unrelated videos to guide potential interested users to watch the one it uploaded. In this way, unrelated likes and comments may destroy the atmosphere of the comment region of the other videos, bringing in an inefficient way of attracting people.

The embodiments of the disclosure provide methods for interacting on social media using social media accounts. The methods may be executed by an electronic device. After obtaining an interactive request to interact with a target group from a requesting account and determining a type of a social relationship between the requesting account and each account in the target group, the electronic device may fulfill the interactive request in response to determining that the type of the social relationship between the requesting account and each account in the target group is the same as the type of the social relationship between accounts in the target group. It may realize interaction among accounts in the group having a specific type of social relationships (that is, the same type of social relationships).

It should be noted that user information and information associated with user accounts, obtained and described in some embodiments of the disclosure, including social relationship information, user identity information, etc., has been fully authorized by users. On the premise of obtaining user license authorization, methods, devices, equipment, servers, storage media, etc. involved in the disclosure may obtain information associated with users.

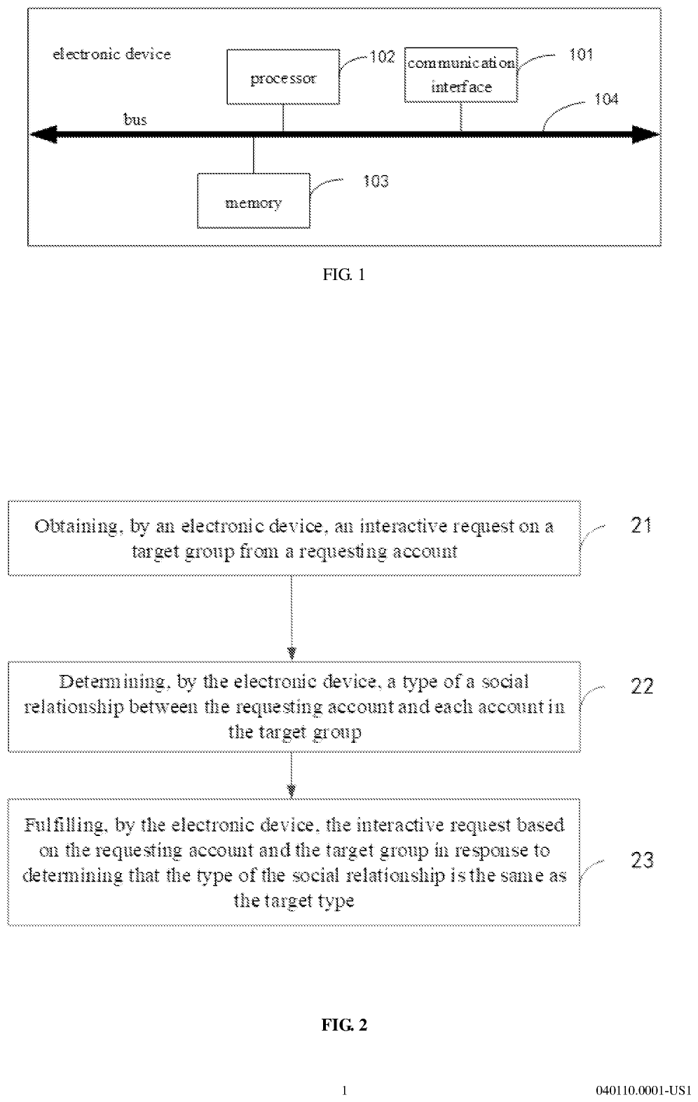

FIG. 1 is a schematic diagram illustrating an electronic device according to some embodiments of the disclosure. The electronic device may be, for example, a terminal and/or a server. The electronic device may include a processor 102. The processor 102 may be configured to execute application program codes to implement the method for interacting on social media accounts described in the present disclosure.

The processor 102 may be a central processing unit (CPU), a microprocessor, an application-specific integrated circuit (ASIC), and/or one or more integrated circuits for controlling the execution of programs described in the present disclosure.

As illustrated in FIG. 1, the electronic device may further include a memory 103. The memory 103 may be configured to store application program codes described in the disclosure for execution. The application program codes may be executed by the processor 102.

The memory 103 may be a read-only memory (ROM) or any type of static storage device that may store static information and instructions, a random access memory (RAM) or any type of dynamic storage device that may store information and instructions, or may be an electrically erasable programmable read-only memory (EEPROM), a compact disc read-only memory (CD-ROM) or other compact disk storage, an optical disk storage (including compact discs, laser discs, optical discs, digital versatile discs, Blu-ray discs, etc.), a magnetic disk storage media or other magnetic storage device, or any other medium for carrying or storing desired program codes that are in the form of instructions or data structures and read by a computer, which is not limited herein. The memory 103 may either be an independent device or may be coupled to the processor 102 through a bus 104 or be integrated with the processor 102.

As illustrated in FIG. 1, the electronic device may further include a communication interface 101. The communication interface 101, the processor 102, and the memory 103 may be coupled to each other, for example, via the bus 104. The communication interface 101 may be configured to interact with other devices such as the electronic device and any other suitable devices.

It should be noted that the structure in FIG. 1 may not constitute a limitation on the electronic device. In addition to components illustrated in FIG. 1, the electronic device may include more or less components than those illustrated in the figure, or a combination of components, or different component arrangements.

The method for interacting on social media using social media accounts provided in some embodiments of the disclosure will be described below with reference to the drawings.

FIG. 2 illustrates a method for interacting on social media using social media accounts according to some embodiments of the disclosure. The method may be executed by an electronic device. As illustrated in FIG. 2, the method may include the following steps.

At step 21, the electronic device may obtain, from a requesting account, an interactive request to interact with a target group.

A social relationship between accounts in the target group satisfies a target type. In particular, the target type may be any type of social relationship, such as a family relationship in real life, a “family” relationship in a game, a “family” relationship as a community, etc.

More particularly, if the electronic device is the server, the server receives the interactive request from the terminal.

If the electronic device is the terminal, the terminal may obtain the interactive request by responding to an operation requested by the requesting account (for example, triggering a control that generates an interactive request, clicking on a link that generates an interactive request, or clicking on an icon that generates an interactive request).

In some embodiments, if the electronic device is the terminal and if the interactive request is to join the target group, the interactive request to interact with the target group may be obtained from the requesting account by performing one or more of the following operations.

In one implementation, the electronic device may display an activity control on a target page of the requesting account and obtain and display a list of group identifiers in response to a trigger instruction on the activity control. The electronic device may then obtain the interactive request by detecting a trigger operation on an identifier of the target group in the list of group identifiers by the requesting account. The target page may be a personal homepage or media resource display page of the requesting account.

In this implementation, the electronic device may display the activity control on the target page of the requesting account to prompt the account to trigger the activity control to display the list of group identifiers. The account may be prompted to join the target group.

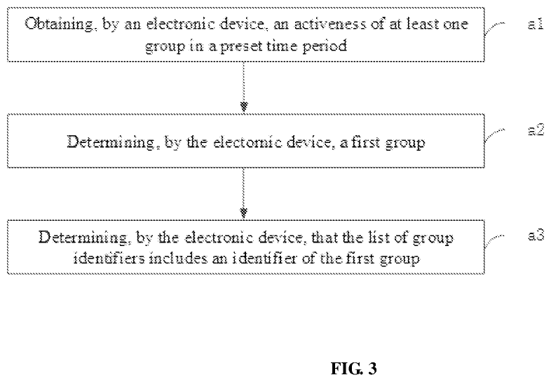

In particular, FIG. 3 illustrates a method for obtaining the list of group identifiers by the electronic device. The method may include steps a1-a3 described below.

At step a1, the electronic device may obtain an activeness of one or more groups in a preset time period.

The preset time period may be a default value or a value set by the relevant management personnel based on actual situations. For example, the preset time period may be 24 hours.

In particular, the electronic device may obtain the activeness of each group of the one or more groups by performing a processing operation on each of the one or more groups. The processing operation may include:

obtaining activeness parameters of a second group in the preset time period, and

obtaining an activeness of the second group by weighting the activeness parameters.

The activeness parameters may include at least one of a number of media resources published by accounts of the second group, a number of comments on the media resources published by the accounts of the second group, or a number of accounts newly associated with the accounts of the second group. The second group may be any group in the one or more groups.

In terms of the video application, the media resources published by the accounts may be videos, text content, etc. The comments on the media resources published by the accounts may be comments on the video or the text content published by the accounts. The accounts newly associated with the accounts may be new fans of the accounts.

In particular, when the electronic device weights the activeness parameters, a weight value of each parameter in the activeness parameters may be a default value, or a value set by the relevant management personnel based on actual situations.

In this implementation, the electronic device may obtain the activeness of each group based on the activeness parameters. The activeness parameters may include at least one of the number of the media resources published by the accounts of the group, the number of the comments on the media resources published by the accounts of the group, and the number of the accounts newly associated with the accounts of the group. In this way, to increase the activeness of the group, an account in the group should increase the values in the activeness parameters. In this way, the account may be a heavy user of the video application.

At step a2, the electronic device may determine a first group.

The first group may be a group in the one or more groups whose activeness satisfies a group recommendation condition.

In particular, after obtaining the activeness of each group, the electronic device may determine the group whose activeness satisfies the group recommendation condition as the first group.

The group recommendation condition may be that the activeness is ranked before the first threshold, or the activeness is greater than the second threshold. The first threshold and the second threshold may be both preset default values, or values set by the relevant management personnel based on actual situations.

In some embodiments, after obtaining the activeness of each group, the electronic device sorts one or more groups based on the activeness and determines the top 50 groups (that is, the first threshold is 50) as the first group.

At step a3, the electronic device may determine that the list of group identifiers includes an identifier of the first group.

In detail, after determining the first group, the electronic device may add the identifier of the first group to the list of group identifiers.

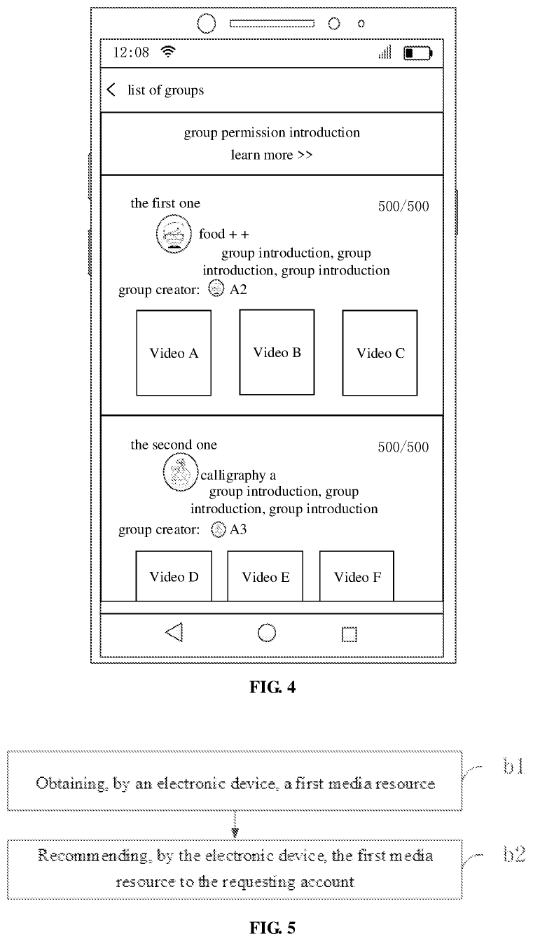

In some embodiments, FIG. 4 illustrates an example of a list of group identifier displayed by the electronic device when the electronic device is the terminal. The list of group identifiers may include conditions for joining the group, group names, group avatars, group introductions, group creators, videos that satisfy a target condition in the group, and the number of members in the group. The target condition may be that the video has been published recently and the number of likes is ranked before the third threshold. The third threshold may be a preset value, or a value set by the relevant management personnel based on actual situations.

In the above solution, the electronic device obtains the list of group identifiers based on the activeness of each group. In this way, it would encourage the accounts in each group to increase the activeness of the group.

In some embodiments, if the electronic device is the terminal and the interactive request is for requesting to join the target group, the interactive request on the target group may be obtained from the requesting account by the following.

In another implementation, the electronic device may display the identifier of the target group having been joined by a target account on the personal homepage of the target account. The electronic device may further receive a trigger operation on the identifier of the target group to obtain the interactive request. The trigger operation may be performed by the requesting account. For example, account A is a requesting account, and account B is the target account since it has joined the target group. Account A enters the personal homepage of account B, clicks the identifier of the target group to apply to join the target group, The electronic device then receives the interactive request.

At step 22, the electronic device may determine a type of a social relationship between the requesting account and each account in the target group.

More particularly, the electronic device may obtain social relationship information of the requesting account and determine the type of the social relationship based on the social relationship information. The social relationship information may include a list of accounts that have social relationships with the requesting account and corresponding types of social relationship.

For example, Table 1 illustrates the social relationship information of the requesting account, including account A, account B, and account C that have social relationships with the requesting account. The type of the social relationship between the requesting account and account A is the family relationship (such as relatives) in real life. The type of the social relationship between the requesting account and account B is the “family” relationship in a game (such as teammate relationship, mentor-disciple relationship). The type of the social relationship between the requesting account and account C is the “family” relationship as a community (such as neighborhood relationship, alumni relationship).

TABLE 1

| | |
|---|---|
| account | social relationship type |

| | | |
|---|---|---|
| requesting account | account A | family relationship in real |
| | | life |
| | account B | “family” relationship in a |
| | | game |
| | account C | “family” relationship as a |
| | | community |

Optionally, the method of obtaining the social relationship information of the requesting account may be to retrieve history records of the requesting account and determine the social relationship information of the requesting account based on the retrieved history records.

In terms of the video application, the history records of the requesting account may be chat records, “long play” records, comment records, like records, etc. The “long play” may refer to the duration that the account plays the media resource exceeding the preset duration. For example, in the chat records with account C, the number of times that a school name appears is greater than a threshold. In the long play records, the publisher account C of the long play media resource is a member in the school. In the comment records, the requesting account has commented the media resources about the school and published by account C. In the like records, the requesting account has liked the media resources about the school and published by account C. In the above scenarios, based on the social relationship information of the requesting account, the type of the social relationship between the requesting account and account C may be determined to be the “family” relationship as a community (i.e., alumni relationship).

Optionally, the method of obtaining the social relationship information of the requesting account may be to retrieve personal information of the requesting account and determine the social relationship information of the requesting account based on the retrieved personal information. For example, if the personal information of both the requesting account and the account C list the same school, based on the social relationship information of the requesting account, the type of the social relationship between the requesting account and account C may be determined to be the “family” relationship as a community (i.e., alumni relationship).

In the above embodiments, the electronic device may determine the social relationship information of the requesting account based on the historical records or personal information of the requesting account and further determine the type of the social relationship between the requesting account and each account of the target group based on the social relationship information. In this way, the electronic device may distinguish different types of the social relationships based on the historical records or personal information, so as to facilitate subsequent interaction with the accounts having the specific social relationship.

At step 23, in response to determining that the type of the social relationship is the same as the target type, the electronic device may fulfill the interactive request based on the requesting account and the target group.

In particular, the interactive request may be a request to recommend a media resource published by an account in the target group to the requesting account, a request to disband the target group, a request to make instant messaging with accounts in the target group, a request to join the target group, a request to quit the target group, or a request to share media resources with accounts in the target group.

In this implementation, in response to determining that the type of social relationship between the requesting account and the account of the target group is the same as the type of the social relationship between the accounts in the target group, the electronic device may perform the interaction between the requesting account and the accounts of the target group. In this way, the interaction is made possible between accounts in the group with a specific type of the social relationship (i.e., sharing the same type of social relationship), and the interaction between the accounts in the same group may be more frequent.

In addition, in terms of the video application, the above embodiment may ensure the interaction between accounts with the specific type of social relationship and may promote the usage of the video application.

Optionally, if the interactive request is to recommend to the requesting account a media resource published by an account in the target group, the method for performing the interactive request, as illustrated in FIG. 5, may include the following steps.

Step b1, the electronic device may obtain a first media resource.

A publisher of the first media resource belongs to the target group. In terms of the application, the first media resource may be a first video and the publisher of the first video belongs to the target group.

In particular, if the electronic device is the server, the electronic device may receive a request from the terminal to obtain the first media resource and may obtain the first media resource published by the account in the target group.

If the electronic device is the terminal, the electronic device may generate a request to obtain the first media resource in response to a request from the requesting account to recommend the media resource (such request may be made by refreshing the media resource display page), and may send the request to obtain the first media resource to the server. The electronic device then may receive the first media resource from the server.

At step b2, the electronic device may recommend the first media resource to the requesting account.

In detail, if the electronic device is the server, the electronic device may send the first media resource to the terminal corresponding to the requesting account. If the electronic device is the terminal, the electronic device may display the first media resource.

Optionally, when the electronic device recommends media resources to the requesting account, the first media resource may have a higher priority than other media resources. Publishers of other media resources may not belong to the target group.

In this implementation, the premise for performing the interactive request is that the type of the social relationship between the requesting account and the account of the target group is the same as the type of the social relationship between the accounts in the target group. In this way, when the requesting account has a need to recommend media resources, the electronic device may recommend the media resources published by the accounts in the target group to the requesting account preferentially. This way of recommending to the requesting account the media resource published by the account having the same type of the social relationship may promote the dissemination of media resources.

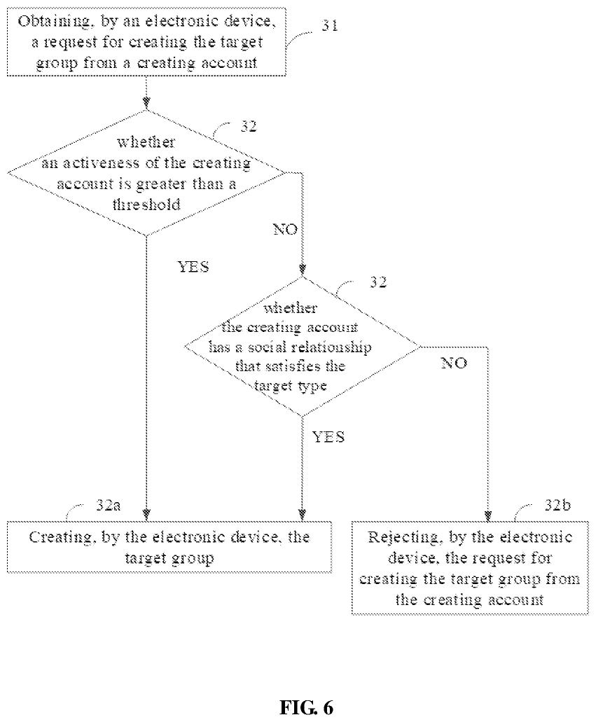

Optionally, as illustrated in FIG. 6, the method for interacting on social media using social media accounts further includes the following steps.

At step 31, the electronic device may obtain, from a creating account, a request to create the target group.

In particular, if the electronic device is the server, the electronic device may receive from the creating account of the terminal the request to create the target group.

If the electronic device is the terminal, the electronic device may respond to a request from the creating account to create the target group (such request may be made by clicking on a group creation control displayed on the personal homepage) and then display a group creation page. The group creation page may include feature prompt information and a creating control of the target group. The electronic device may then generate the request to create the target group in response to a trigger operation on the creating control by the creating account. The feature prompt information may be configured to prompt the creating account to input the feature information of the target group. For example, the feature prompt information may include a prompt to choose a group avatar, a prompt to input a group name, a prompt to input a group introduction, etc.

At step 32, the electronic device determines whether an activeness of the creating account is greater than a threshold, or whether the creating account has a social relationship that satisfies the target type.

In particular, the electronic device may determine the activeness of the creating account. The electronic device may determine the activeness based at least on the behavior of the creating account in the video application. For example, the activeness may be determined based on the number of videos posted by the creating account during a time period, user interactions such as likes, comments, and long play of other videos of the creating account during a time period, etc.

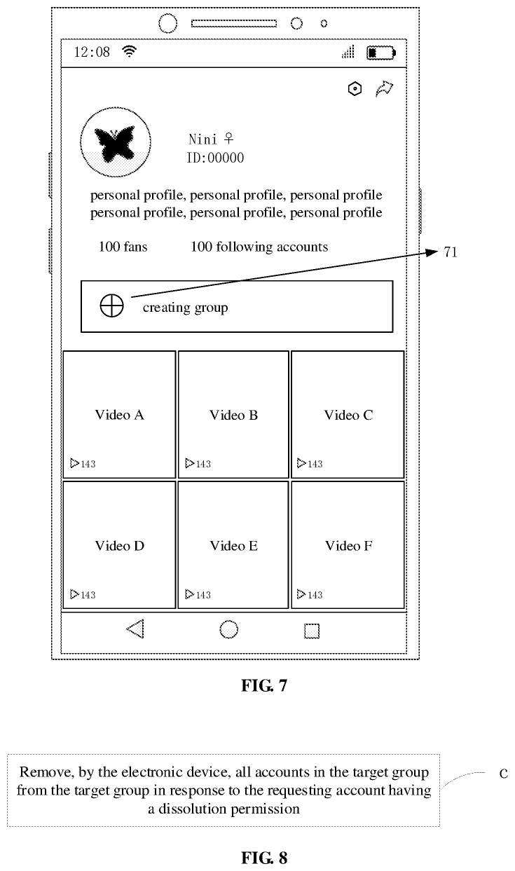

If the electronic device determines that the activeness of the creating account is greater than the threshold, a group creation control may be displayed on the personal homepage of the creating account. In some embodiments, FIG. 7 illustrates the personal homepage of the creating account, including the nickname, ID, profile, number of fans, number of following accounts of the creating account, and video information published by the creating account. If the electronic device determines that the activeness of the creating account is greater than the threshold, the group creation control 71 may be displayed on the personal homepage of the creating account to guide the creating account to create the group.

In addition, the method for determining whether the creating account has a social relationship that satisfies the target type may be the same as step 22, which will be repeated herein. After determining that the creating account has the social relationship that satisfies the target type, the electronic device may display the group creation control on the personal homepage of the creating account to guide the creating account to create the group.

Step 32a, the electronic device may create the target group in response to determining that the activeness of the creating account is greater than the threshold, or in response to determining that the creating account has the social relationship that satisfies the target type.

Step 32b, the electronic device rejects the request from the creating account to create the target group after determining that the activeness of the creating account is less than or equal to the threshold, or determining that the creating account doesn't have the social relationship that satisfies the target type.

In the above solution, after determining that the activeness of the creating account is greater than the threshold or the creating account has the social relationship that satisfies the target type, the electronic device may allow the creating account to create the target group. In this way, accounts with the activeness greater than the threshold or with the social relationship that satisfies the target type may be aggregated in the group, which provides a feasible way for the interaction among the accounts with the same type of the social relationship, thus promoting the activeness among those accounts.

Optionally, the method for interacting on social media using social media accounts also may include the following operations.

When the electronic device is the terminal, the electronic device may display an account removal control on a member listing page of the target group corresponding to the creating account, and then display the removal prompt in response to the trigger operation on the account removal control by the creating account. The removal prompt may be configured to prompt that the account corresponding to the triggered removal control has been removed from the target group.

In detail, displaying the removal prompt information in response to the trigger operation on the account removal control may include the following.

In some embodiments, the electronic device may send an account removal request to the server in response to a trigger instruction on the account removal control. The account removal request may include the identifier of the target group and the identifier of the account corresponding to the removal control. The electronic device may receive from the server an instruction to display the removal prompt and display the removal prompt.

In detail, displaying the removal prompt information in response to the trigger operation on the removal control includes the following.

In other embodiments, the electronic device removes from the target group the identifier of the account corresponding to the removal control in response to a trigger instruction on the account removal control and displays the removal prompt.

Optionally, if the interactive request is to disband the target group, the method for performing the interactive request may include the following step c, as illustrated in FIG. 8.

At step c, the electronic device may remove all accounts in the target group from the target group in response to determining that the requesting account has a dissolution permission (a permission dissolve the group).

In particular, in response to determining that the interactive request is to dissolve the target group, the electronic device may determine whether the identity of the creator of the target group is the same as the identity of the requesting account. If the identity is the same as the electronic device may determine that the requesting account has the dissolution permission. The electronic device may then remove all accounts in the target group from the target group.

Optionally, when the electronic device is the terminal and all accounts in the target group are removed from the target group, the electronic device may display a dissolution prompt. The dissolution prompt may be configured to display that the target group has been dissolved.

In this implementation, the creating account may have the right to disband the group it created and the right to manage accounts in the group it created (e.g., to remove other account from the group it created).

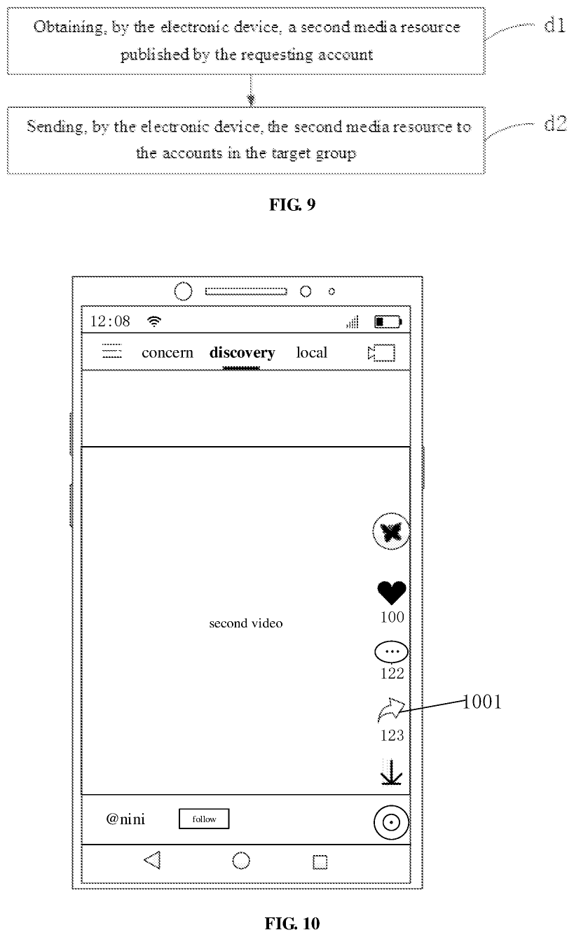

Optionally, the interactive request is a request to share information with accounts in the target group in real time in some embodiments. In such embodiments, the method for performing the interactive request based on the requesting account and the target group by the electronic device may include the following steps d1 and d2, as illustrated in FIG. 9.

At step d1, the electronic device may obtain a second media resource published by the requesting account.

In the video social media application, the second media resource may be a video, text content, etc.

At step d2, the electronic device may send the second media resource to the accounts in the target group.

In this implementation, the requesting account may send media resources to the accounts in the target group to have instant messaging with the accounts in the target group.

Optionally, if the interactive request is to share media resources with accounts in the target group, the method for performing the interactive request based on the requesting account and the target group by the electronic device may include the following.

The electronic device may obtain a third media resource, and then send the third media resource to the accounts in the target group. The third media resource may be the media resource displayed on the media resource display page of the requesting account.

In detail, if the electronic device is the terminal, when the requesting account displays the third media resource, the electronic device may display at least one application icon in response to the sharing instruction. Then the electronic device may display the identifier of the target group in response to the trigger instruction on the video application icon. The electronic device may display on the chat page of the target group the third media resource in response to the trigger instruction on the identifier of the target group.

The at least one application icon may include the video application icon. In terms of the video application, the third media resource may be the second video.

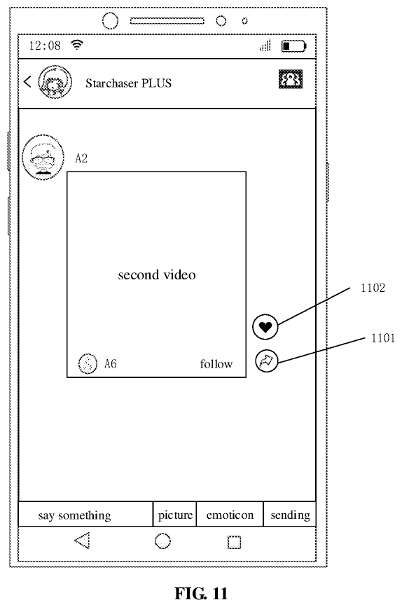

In some embodiments, if the requesting account finds the second video interesting when watching it on the page of video details (i.e., the media resource display page), it may share the second video to the target group by triggering the sharing control of the second video. As illustrated in FIG. 10, the page of video details of the requesting account may include the second video, the publisher of the second video, the sharing control 1001, the comment control, the like control, the download control, etc.

In some embodiments, FIG. 11 illustrates the chat page of the target group when the electronic device displays the second video (i.e., the third media resource) on the page. The chat page of the target group may include the name of the target group, the identifier of the requesting account, the second video, the sharing control 1101 of the second video, the like control 1102, the picture selection control, the emoticon selection control, the sending control, etc. Accounts in the target group may trigger the sharing control 1101 to re-forward the second video, trigger the like control 1102 to like the second video, trigger the picture selection control to send the picture in to the target group, trigger the emoticon selection control to send the emoticon to the target group, etc.

In the above embodiment, the account may share the video being played to the target group thereby promoting the interaction between the accounts. This prevents the account from leaving a comment under other unrelated videos with the aim to increase the play rate of this video.

Optionally, if the interactive request is to join the target group, the electronic device may add the requesting account to the target group and may add an identifier of the target group to the requesting account.

In particular, if the electronic device is the terminal, after confirming that the requesting account has joined the target group, the electronic device may display the identifier of the target group on the personal homepage, media resource display page, and comment page of the requesting account.

Optionally, if the electronic device is the terminal, the electronic device may display the page of group details of the target group in response to a trigger operation on the identifier of the target group. For example, when the requesting account or another account clicks on the identifier of the target group, the electronic device may display the page of group details of the target group.

Optionally, if the interactive request is to quit the target group, the electronic device may remove the requesting account from the target group.

In the above embodiment, the identifier of the target group may be displayed on the personal homepage, media resource display page, and comment page of the requesting account, which may distinguish accounts having a group from those without one, thus satisfying the account's sense of social identity and improving the retention period of the account.

Some embodiments of the disclosure may divide an apparatus for interacting on social media using social media accounts into functional modules based on the above method embodiments. For example, each functional module may correspond to each function. As an alternative, two or more functions may be integrated into one processing module. The above-mentioned integrated module may be implemented in the form of hardware or software functional module. It should be noted that the division of modules in some embodiments of the disclosure is illustrative, is only a logical function division, and there may be other division manners in actual implementation.

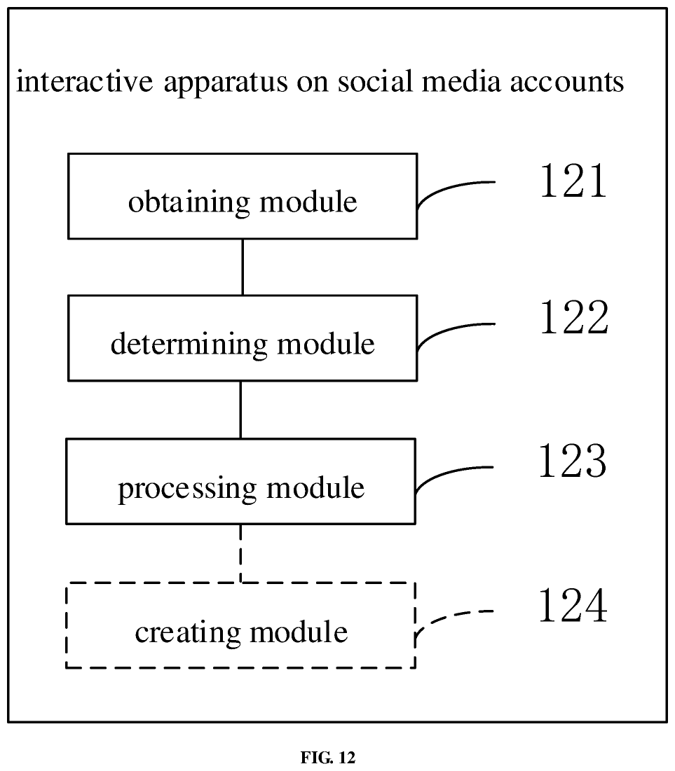

The method provided by some embodiments of the disclosure is described in detail above with reference to FIG. 2 to FIG. 10. Hereinafter, the apparatus for interacting on social media using social media accounts according to some embodiments of the disclosure will be described in detail with reference to FIG. 12. It should be understood that the description of the apparatus embodiments corresponds to the description of the method embodiments. Therefore, for the content that is not described in detail, reference should be made to the above method embodiments. For the sake of brevity, it will not be repeated herein.

FIG. 12 illustrates an apparatus for interacting on social media using social media accounts according to in some embodiments of the disclosure. The apparatus may be implemented using the electronic device or a chip of the electronic device. The electronic device may be the terminal or the server. As illustrated in FIG. 12, the interactive apparatus on social media accounts may include an obtaining module 121, a determining module 122 and a processing module 123.

The obtaining module 121 may be configured to obtain, from a requesting account, an interactive request to interact with a target group. A social relationship between accounts in the target group satisfies a target type. For example, with reference to FIG. 2, the obtaining module 121 may be configured to perform the step 21.

The determining module 122 may be configured to determine a type of a social relationship between the requesting account and each account in the target group. For example, with reference to FIG. 2, the determining module 122 may be configured to perform the step 22. The processing module 123 may be configured to perform the interactive request after the type of the social relationship determined in the module 122 is the same as the target type. For example, with reference to FIG. 2, the processing module 123 may be configured to perform step 23.

Optionally, the determining module 122 may be configured to obtain social relationship information of the requesting account and determine the type of the social relationship based on the social relationship information of the requesting account. The social relationship information may include a list of accounts that have social relationships with the requesting account and types of the social relationships.

Optionally, if the interactive request is to recommend to the requesting account a media resource published by an account in the target group, the processing module 123 may be configured to obtain a first media resource and recommend the first media resource to the requesting account. For example, with reference to FIG. 5, the processing module 123 may be configured to perform steps b1-b2. A publisher of the first media resource belongs to the target group.

Optionally, the apparatus may further include a creating module 124. The obtaining module 121 may be further configured to obtain from a creating account a request to create the target group. For example, with reference to FIG. 6, the obtaining module 121 may further be configured to perform the step 31. The creating module 124 may be configured to create the target group if an activeness of the creating account is greater than a threshold, or if the creating account has a social relationship that satisfies the target type. For example, with reference to FIG. 6, the creating module 124 may be configured to perform the steps 32-32b.

Optionally, if the interactive request is to disband the target group, the processing module 123 may be configured to remove all accounts in the target group from the target group after determining that the requesting account has a dissolution permission. For example, with reference to FIG. 8, the processing module 123 may be configured to perform the step c.

Optionally, if the interactive request is to have instant messaging with accounts in the target group, the processing module 123 may be configured to obtain a second media resource published by the requesting account and send the second media resource to the accounts in the target group. For example, with reference to FIG. 9, the processing module 123 may be configured to perform the steps d1-d2.

Optionally, if the interactive request is to join the target group, the processing module 123 may be configured to add the requesting account to the target group and adding an identifier of the target group to the requesting account. As an alternative, if the interactive request is to quit the target group, the processing module 123 may be configured to remove the requesting account from the target group.

Optionally, if the interactive request is to join the target group, the obtaining module 121 may be configured to display an activity control on a target page of the requesting account, then obtain and display a list of group identifiers in response to a trigger instruction on the activity control, and finally obtain the interactive request after receiving a trigger operation from the requesting account on an identifier of the target group in the list of group identifiers. The target page may be a personal homepage or medial resource display of the requesting account.

Optionally, the obtaining module 121 may be configured to obtain an activeness of one or more groups in a preset time period, determine a first group, and confirm that the list of group identifiers comprises an identifier of the first group. For example, with reference to FIG. 3, the obtaining module 121 may be configured to perform the steps a1-a3. The first group may be a group in the one or more groups whose activeness satisfies a group recommendation condition

Optionally, the obtaining module 121 may be configured to obtain the activeness of each group by a processing operation on each group in one or more groups. The processing operation may include obtaining activeness parameters of a second group in a preset time period and obtaining an activeness of the second group by weighting the activeness parameters. The activeness parameters may include at least one of a number of media resources published by accounts of the second group, a number of comments on the media resources published by the accounts of the second group, and a number of accounts newly associated with the accounts of the second group. The second group may be any group in one or more groups.

A computer-readable storage medium which may store instructions is provided according to some embodiments of the disclosure. When the instructions run on an electronic device, the electronic device may execute any methods in the above embodiments illustrated in FIG. 2 to FIG. 11.

A computer program product is also provided according to some embodiments of the disclosure. The computer program product includes computer-executable instructions which are stored in a computer-readable storage medium. The processor of the electronic device may read the computer-executable instructions from the computer-readable storage medium and execute the computer-executable instructions. As such, the electronic device may execute any of methods in the above embodiments illustrated in FIG. 2 to FIG. 11.

With respect to the apparatuses in the above embodiments, the specific manners for performing operations for individual modules therein have been described in detail in the embodiments regarding the methods, which will not be elaborated herein.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for interacting on social media using social media accounts, comprising:
obtaining, from a requesting account, an interactive request to interact with a target group, wherein a social relationship between accounts in the target group satisfies a target type;
determining a type of a social relationship between the requesting account and each account in the target group; and
in response to determining that the type of the social relationship is the same as the target type, fulfilling the interactive request based on the requesting account and the target group.

2. The method as claimed in claim 1, wherein determining the type of the social relationship between the requesting account and each account in the target group comprises:
obtaining social relationship information of the requesting account, wherein the social relationship information comprises a list of accounts that have social relationships with the requesting account and corresponding types of social relationships; and
determining the type of the social relationship based on the social relationship information of the requesting account.

3. The method as claimed in claim 1, wherein the interactive request comprises a request for recommending a media resource published by an account in the target group to the requesting account, and wherein performing the interactive request based on the requesting account and the target group comprises:
obtaining a first media resource, wherein a publisher of the first media resource belongs to the target group; and
recommending the first media resource to the requesting account.

4. The method as claimed in claim 1, further comprising:
obtaining, from a creating account, a request to create the target group;
creating the target group in response to determining that an activeness of the creating account is greater than a threshold or in response to determining that the creating account has a social relationship that satisfies the target type.

5. The method as claimed in claim 4, wherein the interactive request comprises a request for dissolving the target group, and wherein performing the interactive request comprises:
removing all accounts in the target group from the target group in response to determining that the requesting account has a dissolution permission.

6. The method as claimed in claim 1, wherein the interactive request comprises a request to share information with accounts in the target group, and wherein performing the interactive request based on the requesting account and the target group comprises:
obtaining a second media resource published by the requesting account; and
sending the second media resource to the accounts in the target group.

7. The method as claimed in claim 1, wherein performing the interactive request based on the requesting account and the target group comprises:
removing the requesting account from the target group in response to determining that the interactive request comprises a request is to quit the target group.

8. The method as claimed in claim 1, wherein the interactive request comprises a request to join the target group, wherein performing the interactive request based on the requesting account and the target group comprises adding the requesting account to the target group and adding an identifier of the target group to the requesting account in response to determining that the interactive request comprises a request to join the target group. and wherein obtaining, from the requesting account, the interactive request to interact with the target group comprises:
displaying an activity control on a target page of the requesting account, wherein the target page is a personal homepage or media resource display page of the requesting account;
obtaining and displaying a list of group identifiers in response to a trigger instruction on the activity control; and
obtaining the interactive request by receiving a trigger operation from the requesting account on an identifier of the target group in the list of group identifiers.

9. The method as claimed in claim 8, wherein obtaining the list of group identifiers comprises:
obtaining an activeness of at least one group in a preset time period;
determining a first group, wherein the first group is a group in the at least one group whose activeness satisfies a group recommendation condition; and
confirming that the list of group identifiers comprises an identifier of the first group.

10. The method as claimed in claim 9, wherein obtaining the activeness of the at least one group in the preset time period comprises:
obtaining the activeness of each group by a processing operation on each group in the at least one group,
wherein the processing operation comprises:
obtaining activeness parameters of a second group in the preset time period; and
obtaining an activeness of the second group by weighting the activeness parameters,
wherein the activeness parameters comprise at least one of a number of media resources published by accounts of the second group, a number of comments on the media resources published by the accounts of the second group, or a number of accounts newly associated with the accounts of the second group, and
wherein the second group is any group in the at least one group.

11. An electronic device, comprising:
a processor; and
a memory for storing instructions executable by the processor,
wherein the processor is configured to execute the instructions to:
obtain, from a requesting account, an interactive request to interact with a target group, wherein a social relationship between accounts in the target group satisfies a target type;
determine a type of a social relationship between the requesting account and each account in the target group; and
fulfill the interactive request based on the requesting account and the target group in response to determining that the type of the social relationship is the same as the target type.

12. The electronic device as claimed in claim 11, wherein the processor is further configured to execute the instructions to:
obtain social relationship information of the requesting account, wherein the social relationship information comprises a list of accounts that have social relationships with the requesting account and corresponding types of social relationships; and
determine the type of the social relationship based on the social relationship information of the requesting account.

13. The electronic device as claimed in claim 11, wherein the interactive request comprises a request for recommending a media resource published by an account in the target group to the requesting account, and wherein the processor is further configured to execute the instructions to:
obtain a first media resource, wherein a publisher of the first media resource belongs to the target group; and
recommend the first media resource to the requesting account.

14. The electronic device as claimed in claim 11, wherein the processor is further configured to execute the instructions to:
obtain, from a creating account, a request to create the target group;
create the target group in response to determining that an activeness of the creating account is greater than a threshold or that the creating account having a social relationship that satisfies the target type.

15. The electronic device as claimed in claim 14, wherein the interactive request comprises a request for dissolving the target group, and wherein the processor is further configured to execute the instructions to:
remove all accounts in the target group from the target group in response to determining that the requesting account has a dissolution permission.

16. The electronic device as claimed in claim 11, wherein the interactive request is to have instant messaging with accounts in the target group, and wherein the processor is further configured to execute the instructions to:
obtain a second media resource published by the requesting account; and
send the second media resource to the accounts in the target group.

17. The electronic device as claimed in claim 11, wherein the processor is further configured to:
removing the requesting account from the target group in response to determining that the interactive request comprises a request for quitting the target group.

18. The electronic device as claimed in claim 17, wherein the interactive request comprises a request to join the target group, wherein performing the interactive request based on the requesting account and the target group comprises adding the requesting account to the target group and adding an identifier of the target group to the requesting account in response to determining that the interactive request comprises the request to join the target group and wherein the processor is further configured to:
display an activity control on a target page of the requesting account, wherein the target page is a personal homepage or media resource display page of the requesting account;
obtain and displaying a list of group identifiers in response to a trigger instruction on the activity control; and
obtain the interactive request by receiving a trigger operation from the requesting account on an identifier of the target group in the list of group identifiers.

19. The electronic device as claimed in claim 18, wherein the processor is further configured to execute the instructions to:
obtain an activeness of one or more groups in a preset time period;
determine a first group, wherein the first group is a group in the one or more groups with an activeness satisfies a group recommendation condition; and
determine that the list of group identifiers comprises an identifier of the first group.

20. A non-transitory computer-readable storage medium having stored therein instructions that, when executed by a processor of an electronic device, cause the electronic device to:
obtain, from a requesting account, an interactive request to interact with a target group, wherein a social relationship between accounts in the target group satisfies a target type;
determine a type of a social relationship between the requesting account and each account in the target group; and
perform the interactive request after determining that the type of the social relationship is the same as the target type.
